(19) United States
(12) Patent Application Publication
(10) Pub. No.: US 2023/0078012 A1
(43) Pub. Date: Mar. 16, 2023

(54) UNMANNED AERIAL VEHICLE, A COMPUTER PROGRAM AND A METHOD FOR REDUCING A DAMAGE TO AN ENVIRONMENT AS CONSEQUENCE OF A CRASH OF AN UNMANNED AERIAL VEHICLE

(71) Applicant: Sony Group Corporation, Tokyo (JP)

(72) Inventors: Florian BECKER, Stuttgart (DE); Peter DÜRR, Stuttgart (DE); Matthias FREY, Stuttgart (DE); Henrik SCHÄFER, Stuttgart (DE)

(73) Assignee: Sony Group Corporation, Tokyo (JP)

(21) Appl. No.: 17/798,557

(22) PCT Filed: Feb. 25, 2021
(86) PCT No.: PCT/EP2021/054702

§ 371 Date: Aug. 10, 2022

(30) Foreign Application Priority Data
Feb. 28, 2020 (EP) 20160250.5

(51) Int. Cl. G05D 1/06; B64C 39/02; B64D 1/12; G05D 1/10

(52) U.S. Cl. CPC G05D 1/0688; B64C 39/024; B64D 1/12; G05D 1/101; B64C 2201/18; B64C 2201/128; B64C 2201/141

(57) ABSTRACT

The present disclosure relates to an aerial vehicle for carrying a load. The aerial vehicle comprises an environmental monitoring system configured to monitor the environment of the aerial vehicle and a data processing circuitry. The data processing circuitry is configured to determine, based on the monitored environment, a risk to the environment posed by at least one of the aerial vehicle and the load of the aerial vehicle in case of a crash of the aerial vehicle. The data processing circuitry is further configured to cause, based on the determined risk, the aerial vehicle to carry out an action in order to reduce a damage to the environment in case of the crash.

### FIELD

Embodiments of the present disclosure relate to an aerial vehicle, a computer program and a method for reducing a damage to an environment as consequence of a crash of an aerial vehicle.

### BACKGROUND

An aerial vehicle which is in distress may be a danger for its environment. For example, the aerial vehicle can crash in consequence of critical weather conditions, a technical failure or a malfunction. Thus, the aerial vehicle, and especially, a load of the aerial vehicle may pose a risk to the environment in case of such a crash. Depending on a scenario or an application of the aerial vehicle, such a crash on the one hand may cause material damage of the load, the aerial vehicle and/or the environment, and on the other hand injuries of humans within the environment.

A document US 2017/0297695 A1 discloses a system for assisting in rotor speed control in a rotorcraft by detecting a drop in rotor speed of the rotorcraft.

A concept known from a document U.S. Pat. No. 6,471,160 B2 provide a risk mitigation system for a drone including a parachute deployment system to spare additional or redundant flight relevant systems for backup in case of an imminent crash of the drone.

A further document (US 2019/0156685 A1) discloses a concept for controlling unmanned aerial vehicles experiencing emergency landings and providing an emergency alert to an area proximate a predicted emergency landing location of the unmanned aerial vehicle.

The subject matter of the named documents does not enable the drone to react depending on an environment-specific risk to which an environment of the drone is exposed in case of a crash of the drone. The named documents disclose more of a non-adaptive risk mitigation concept which do not take into account the environment to reduce the damage of the objects or humans therein in case of a crash.

Hence there may be a demand of an adaptive risk mitigation concept in connection with an unmanned aerial vehicle for reducing a damage to an environment of the unmanned aerial vehicle in case of a crash.

### SUMMARY

This demand can be satisfied by the subject matter of hereby appended independent and dependent claims.

According to a first aspect, the present disclosure relates to an aerial vehicle for carrying a load. The aerial vehicle comprises an environmental monitoring system configured to monitor the environment of the aerial vehicle and a data processing circuitry. The data processing circuitry is configured to determine, based on the monitored environment, a risk to the environment posed by at least one of the aerial vehicle and the load of the aerial vehicle in case of a crash of the aerial vehicle. The data processing circuitry is further configured to cause, based on the determined risk, the aerial vehicle to carry out an action in order to reduce a damage to the environment in case of the crash.

The aerial vehicle can be an aircraft or an unmanned aerial vehicle (UAV), for example, for transportation, commercial, scientific, recreational, agricultural or other applications, like for aerial photography or surveillance purposes.

The environmental monitoring system, for example, comprises a camera, a lidar system, a radar system, a Time-Of-Flight camera or another comparable system for monitoring the environment. Thus, the environmental monitoring system can record image data or a digital map of the monitored environment.

The environmental monitoring system especially can monitor the environment beneath the aerial vehicle.

In this way, the environmental monitoring system can enable the data processing circuitry to determine the risk to the environment posed by the load in case of a crash of the UAV based on the monitored environment.

The load, for example, is a photo camera or a parcel.

In order to determine the risk, the data processing circuitry, for example, analyzes the image data or the digital map to characterize the environment and especially objects within the environment which may be damaged in case of the crash. Through a characterization the data processing circuitry may distinguish between human and non-human objects, such as trees, buildings, cars, mountains or water to determine the risk of material and/or human damage in case of the crash.

For this, the data processing circuitry, for example, uses a trained neural network or another comparable machine learning-enabled structure. The neural network, for example, can be trained to detect humans or a crowd in the environment beneath the aerial vehicle to determine from the image data or the digital map whether the crash of the aerial vehicle may involve a risk of human injuries.

Additionally or alternatively the neural network can be trained to detect buildings and/or to characterize a structure of a ground beneath the aerial vehicle to determine whether the crash may involve a risk of material damage to the environment, the aerial vehicle and/or the load of the aerial vehicle.

Consequently, the data processing circuitry can output a control signal to cause the aerial vehicle to carry out an action for reducing or avoiding the material damage or human injuries. Especially, the action can reduce a damage caused by the load of the aerial vehicle in case of the crash.

In some embodiments, the action includes a controlled ejection or a destruction of the load.

According to a second aspect, the present disclosure relates to a method for reducing a damage to an environment as consequence of a crash of an aerial vehicle. The method comprises monitoring the environment of the aerial vehicle. Further, the method provides for determining, based on the monitored environment, a risk to the environment posed by at least one of the aerial vehicle and a load of the aerial vehicle in case of a crash of the aerial vehicle. The method further comprises causing, based on the determined risk, the aerial vehicle to carry out an action in order to reduce the damage to the environment in case of the crash.

The method, for example, can be executed using the aforementioned aerial vehicle.

According to a third aspect, the present disclosure relates to a computer program comprising instructions, which, when the computer program is executed by a processor cause the processor to carry out the aforementioned method.

The computer program, for example, controls the environmental monitoring system and/or the data processing circuitry as described in connection with the above mentioned embodiments.

### BRIEF DESCRIPTION OF THE FIGURES

Some examples of apparatuses and/or methods will be described in the following by way of example only, and with reference to the accompanying figures, in which

FIG. 1 illustrates an unmanned aerial vehicle (UAV) comprising an environmental monitoring system and a data processing circuitry;

FIG. 2a illustrates a first scenario in which the UAV is above a crowd;

FIG. 2b illustrates a second scenario in which the UAV is above water;

FIG. 2c illustrates a third scenario in which the UAV is above a building;

FIG. 3a illustrates an emergency landing of the UAV;

FIG. 3b illustrates a ballistic load drop of the UAV;

FIG. 3c illustrates an active load ejection of the UAV;

FIG. 3d illustrates a tethered load drop of the UAV;

FIG. 3e illustrates a self-destruction of the UAV and/or the load;

FIG. 4 schematically illustrates a method for reducing the damage to an environment as consequence of a crash of the UAV;

FIG. 5a schematically illustrates a first example of a computer program for risk mitigation;

FIG. 5b schematically illustrates a second example of a computer program for risk mitigation; and

FIG. 5c schematically illustrates a third example of a computer program for risk mitigation.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Same or like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled via one or more intervening elements. If two elements A and B are combined using an “or”, this is to be understood to disclose all possible combinations, i.e. only A, only B as well as A and B, if not explicitly or implicitly defined otherwise. An alternative wording for the same combinations is “at least one of A and B” or “A and/or B”. The same applies, mutatis mutandis, for combinations of more than two Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In case of a crash, an unmanned aerial vehicle (UAV) and/or its load can be a risk for its environment. In particular, this risk refers to a risk of damages of the environment or human injuries.

Hence there may be a demand of an adaptive risk mitigation concept in connection with an aerial vehicle for reducing a damage to an environment of the aerial vehicle in case of a crash.

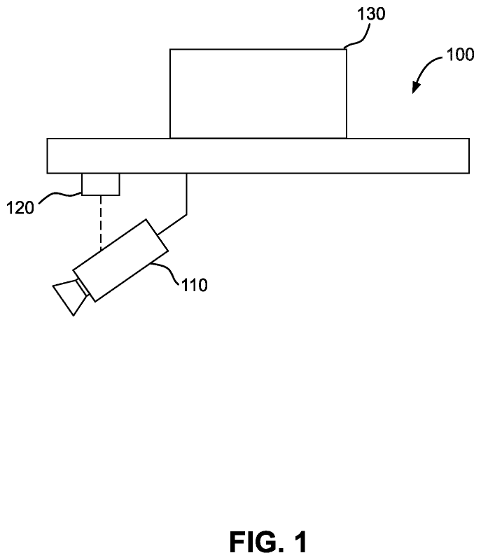

As can be seen in FIG. 1, the aerial vehicle, for example, is an unmanned aerial vehicle (UAV) 100, which carries a load 130.

In further embodiments of the present disclosure, the aerial vehicle can be of any kind of an aircraft. For example, the aerial vehicle can be a helicopter, a sailplane, an airliner or a jet.

The UAV 100 comprises an environmental monitoring system 110 configured to monitor the environment of the UAV 100 and a data processing circuitry 120. As can be seen in FIG. 1, the environmental monitoring system 110, for example, comprises a camera, a lidar sensor, a radar sensor and or a thermal imager configured to provide a (thermal) image and/or a three-dimensional (3D) digital map of the environment, respectively.

The data processing circuitry 120 is configured to determine, based on the monitored environment, a risk to the environment posed by the load 130 in case of a crash of the UAV 100. For this, the data processing circuitry 120 can determine the risk based on the (thermal) image data or the digital map of the environment.

For example, the data processing circuitry 120 can determine whether an imminent crash of the UAV 100 may cause injuries to humans based on the image data of the camera, the lidar sensor or the radar sensor. To this end, the data processing circuitry 120 can utilize a machine-learning based processor which is trained to detect humans based on the image data.

Analogously, the data processing circuitry 120 can determine whether the UAV 100 can cause material damage to the environment by verifying whether buildings or cars are within the environment of the UAV 100.

Additionally or alternatively, the data processing circuitry 120 can detect humans from the thermal image data by their surface temperature.

In general, the data processing circuitry 120 can be attached to the UAV 100 or installed remote from the UAV 100. In the latter case, the environmental monitoring system 110 and the data processing circuitry 120 may communicate wirelessly for transferring the image data and/or the thermal image data and for controlling the UAV 100.

The data processing circuitry 120 can be a data processing machine or as programmable hardware, such as a computer, a processor, a micro controller, a server or the like.

The UAV 100 can further comprise a “pre-crash warning system” (not shown) to predict the imminent crash. For example, the pre-crash warning system can detect a critical weather situation or a technical problem of the UAV causing the imminent crash. Alternatively or additionally, the pre-crash warning system can detect unstable/out of control flight conditions, for example, using an acceleration sensor or an inertial measurement unit (IMU).

In general, the environmental system and the data processing circuitry either can be triggered by the pre-crash warning system to determine the risk to the environment in case of an imminent crash or they can be operated such that they continuously estimate/determine the said risk.

Further, the data processing circuitry can cause the UAV 100, based on the determined risk, to carry out an action in order to reduce a damage to the environment in case of the crash. The action may, depending on the determined risk, consist of any one of one or more possible maneuvers or of doing nothing. Thus, the concept described herein can be understood as a concept for adaptive risk mitigation, as stated in the following in more detail.

In some further embodiments, the UAV 100 comprises a localization system (not shown) which is configured to determine spatial coordinates and a velocity of the UAV 100 and to calculate a crash site of the crash within the environment from the spatial coordinates and the velocity. The data processing circuitry can receive the crash site from the localization system and determine, based on the received crash site, a risk to the crash site posed by the

UAV 100 and/or its load 130 in case of the crash of the aerial vehicle. This, for example, enables to control the UAV 100 such that the UAV 100 will not crash into a crowd or a building within the determined crash site to avoid or reduce material damage or injuries.

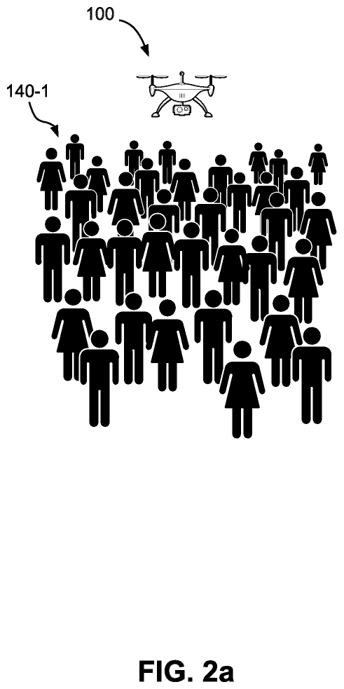

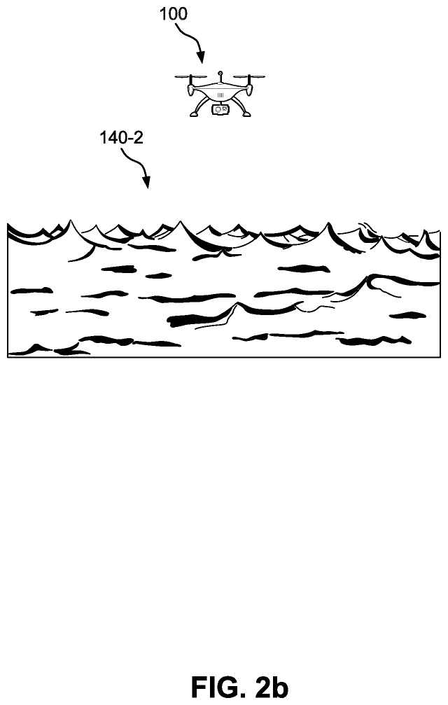

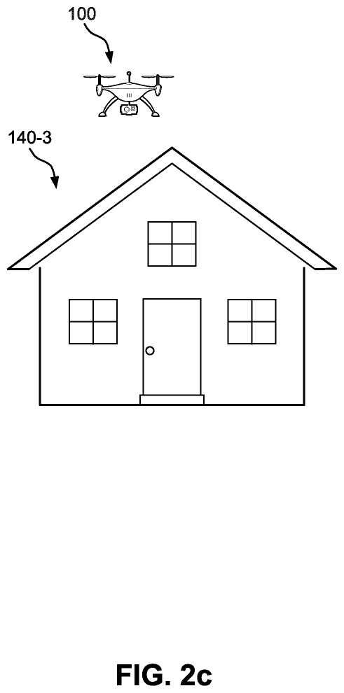

FIG. 2a, FIG. 2b and FIG. 2c illustrate various possible scenarios of the environment and/or the crash site prior to the crash of the UAV 100.

FIG. 2a illustrates a first scenario in which the UAV 100 is above a crowd 140-1. This may be the case, for example, when the UAV 100 is utilized to record a sporting event or a music event.

In a second scenario, shown in FIG. 2b, the UAV 100 is above water 140-2, for example, if the UAV 100 is used for sea rescue.

FIG. 2c illustrates a third scenario. In the third scenario, the UAV 100 is above a building 140-3 which happens, for example, if the UAV 100 is used for recreational or commercial purposes.

As mentioned above, the UAV 100 can carry out an action to reduce the damage to the environment in case of the crash.

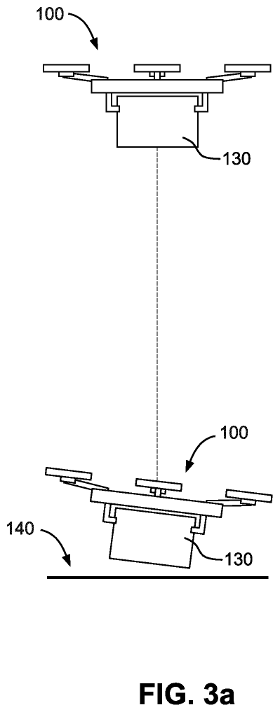

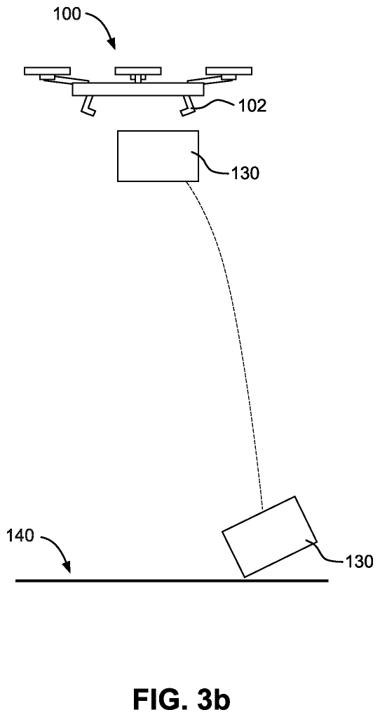

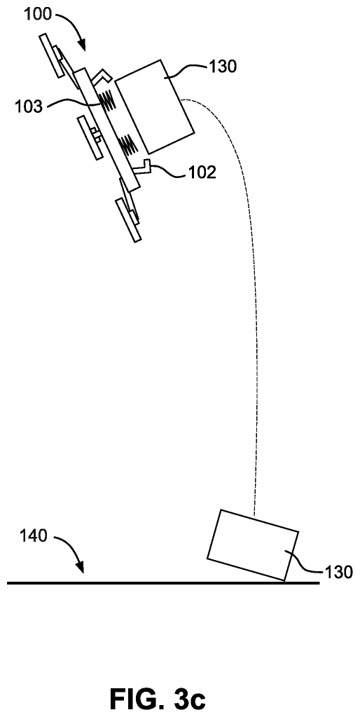

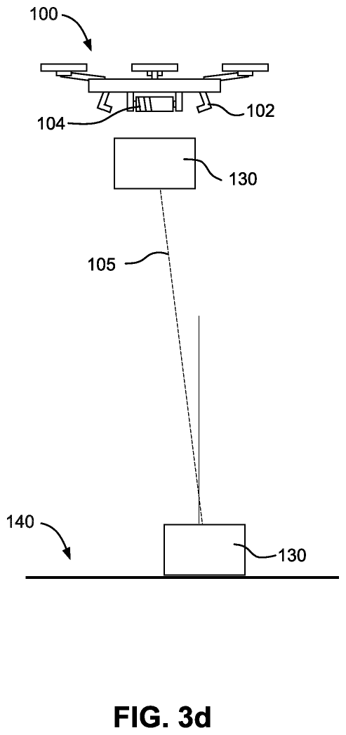

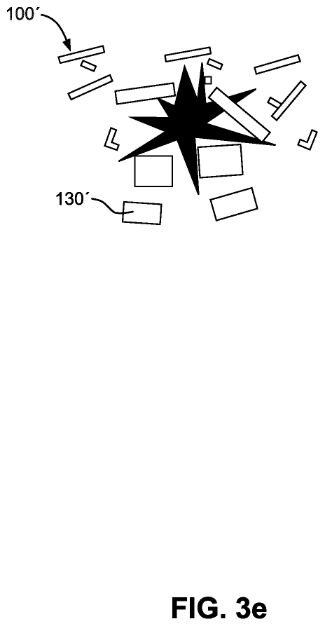

FIGS. 3a, 3b, 3c, 3d and 3e illustrate examples of such an action.

FIG. 3a shows an emergency landing of the UAV 100.

The UAV 100, for example, comprises an energy monitoring system (not shown) which is configured to determine an actuation capability of the aerial vehicle 100 and provide the actuation capability to the data processing circuitry 120.

The actuation capability can be understood as an operational capability or a (remaining) range of the UAV 100. The actuation capability may be indicative of a fuel level or a battery level of the UAV 100.

Moreover, the actuation capability can be influenced by a technical state or a technical problem of the UAV 100 or by a weight of the load.

The data processing circuitry 120 can determine whether the UAV 100 is able to carry out the emergency landing with the (remaining) actuation capability for (safely) landing on the ground 140.

Consequently, the data processing circuitry 120 can trigger the UAV 100 to carry out the emergency landing.

Particularly, if the UAV 100 is above the crowd 140-1, it can perform the emergency landing to reduce or avoid injuries to humans.

FIG. 3b shows a “ballistic load drop”. The UAV 100, for example, comprises a load release system 102 for releasing the load 130 under control of the data processing circuitry 120 in case of an imminent crash.

The load release system 102 can comprise one or more pivoted cleats for retaining the load 130. The pivoted cleats can be actuated by the data processing circuitry 120 for releasing the load 130.

The data processing circuitry 120 can trigger the load release system 102 to release the load 130 in order to increase the actuation capability for the emergency landing or if the emergency landing is (technically) not possible.

In some situations, the UAV 100 can release the load 130 for a controlled impact of the load 130 on the ground 140 to avoid the crash or to prevent the load and/or the UAV 100 from crashing into people or buildings.

FIG. 3c illustrates an active load ejection. In order to perform such an active load ejection, the load release system 102 can be configure to eject the load 130.

To this end, the load 130 is mounted on preloaded springs 103 which can eject the load 130 under control of the data processing circuitry 120.

Alternatively, the load 130 can be ejected by the load release system using an explosive charge.

The data processing circuitry 120 can trigger the ballistic load drop and/or the active load ejection, for example, by forwarding a trigger signal to the release system 102.

The UAV 100 can perform the active load ejection to reduce the damage to the environment. For example, the UAV 100 can avoid or reduce material damage or injuries to people by changing a crash site of the load 130 and/or the UAV 100 through the active load ejection.

FIG. 3d illustrates a “tethered load drop” in which the load release system the UAV 100 safely lowers the load 130 down to the ground 140.

To this end, the load release system 102, for example, comprises a rope winch 104 connecting the load 130 with the UAV 100 via a rope 105. The rope winch 104 can be controlled by the data processing circuitry 120 such that the rope winch 104 lowers down the load 130 on the rope 105.

On the one hand, lowering the load 130 down on the rope 105 allows the UAV 100 to lower down the load 130 in a “controlled fashion” and to reduce an impact of the load 130. On the other hand, the UAV 100 can have an influence on where it crashes through the tethered load drop. Once the load 130 reached the ground 140, it may function like an anchor, for example, to prevent the UAV 100 to collide with the building 140-3 or to crash into the crowd 140-1.

FIG. 3e illustrates a self-destruction of the UAV 100.

For the self-destruction, the UAV 100 can comprise an explosive device (not shown).

The data processing circuitry 120 can trigger the explosive device to explode for decomposing the load 130 and/or the UAV 100 into parts 100′ and 130′ whose impact may be less dangerous or harmful than of the UAV 100 and the load 130 as whole.

Self-destruction of the UAV 100 may particularly prevent humans or the crowd 140-1 from being injured by the crash of the UAV 100.

The actions described above by reference to FIGS. 3a, 3b, 3c, 3d and 3e are exemplary for a larger number of ways to reduce the damage of the environment.

In some embodiments, the UAV 100 comprises a fuel tank (not shown) which is configured to release fuel under control of the data processing circuitry 120. Thus, the data processing circuitry 120 can drain off the fuel prior to the crash to reduce an amount of combustible, hazardous material and/or to reduce a weight of the UAV 100 and thus, to mitigate the impact of the UAV 120 and/ or a risk or extent of fire and/or to increase the actuation capability, as stated above.

For example, the fuel is hydrogen. In some cases it can pose less risk to the environment to release the hydrogen prior to the imminent crash than a crash of the UAV 120 carrying the hydrogen. For example, releasing the hydrogen may avoid a fire as consequence of a crash of the UAV 120 carrying the hydrogen.

Alternatively, the fuel can comprise petrol, ethanol, propane biodiesel and the like.

In some embodiments, the UAV 100 is able to perform multiple of the maneuvers (emergency landing, ballistic load drop, active load ejection, tethered load drop, self-destruction and “fuel drain”) described above. In such embodiments, the data processing circuitry 120 can be configured to determine, based on the monitored environment/scenario, if any maneuver can reduce the damage and which of the maneuvers can “maximally” reduce the damage to the environment in case of the crash.

For example, in the scenario of FIG. 2a, the data processing circuitry 120 preferably may cause the UAV 100 to perform the emergency landing, if it is possible with the remaining actuation capability, instead of the ballistic load drop or the self-destruction, to avoid (unnecessary) material damage and/or injuries.

Otherwise, if the actuation capability is not sufficient for the emergency landing, the data processing circuitry 120 may preferably initiate the self-destruction in the scenario of FIG. 2a instead of dropping the load 130 to avoid or reduce injuries.

In other situations, the data processing circuitry 120 may cause the UAV 100 to perform a combination or none of the maneuvers described above.

Generally, the action may also consist of doing nothing, if the damage of the environment would not be reduced in consequence of any maneuver.

Taking the scenario of FIG. 2b for example, the UAV 100 and/or the load 130 may not suffer any damage if it falls into the water 140-2, regardless of any maneuvers. In this scenario, the data processing circuitry 120, for example, does not initiate dropping the load 130 or self-destructing to make it easier to recover the UAV 100 and/or the load 130.

Since the maneuver to be executed can adaptively be determined by the UAV 100, the concept described by reference to the illustrated examples can be understood as a concept for adaptive risk mitigation.

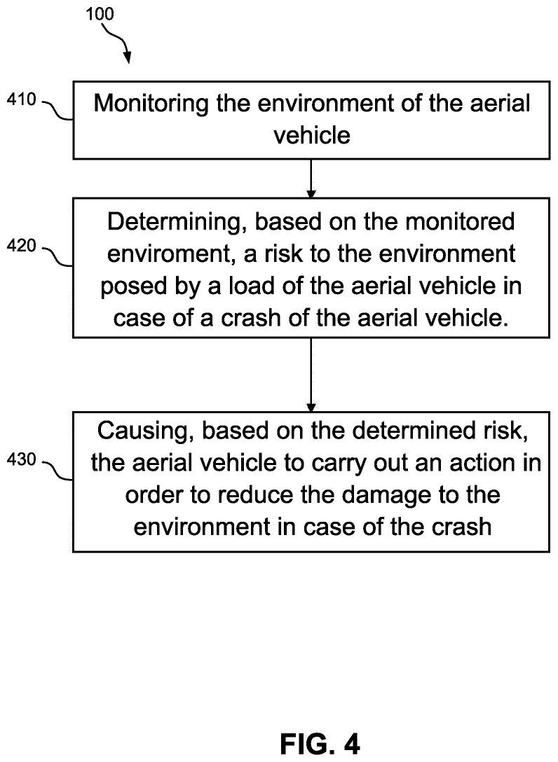

FIG. 4 illustrates a method 400 for reducing a damage to an environment as consequence of a crash of an aerial vehicle. The method 400 comprises monitoring 410 the environment of the aerial vehicle. Further, the method 400 provides for determining 420, based on the monitored environment, a risk to the environment posed by at least one of the aerial vehicle and a load of the aerial vehicle in case of a crash of the aerial vehicle. Moreover, the method 400 comprises causing 430, based on the determined risk, the aerial vehicle to carry out an action in order to reduce the damage to the environment in case of the crash.

The method 400 can be executed by the aforementioned aerial vehicle/UAV 100. Hence, the method 400 may also include any of the features described above in connection with the aerial vehicle/UAV 100.

The aforementioned method 400 or at least steps thereof, can be initiated and/or controlled by a computer program.

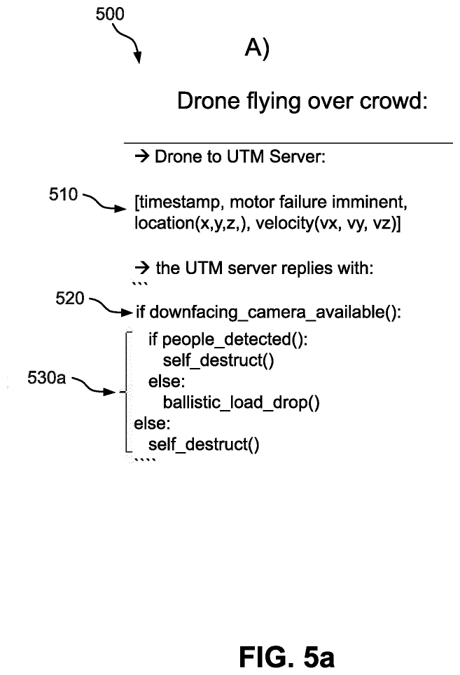

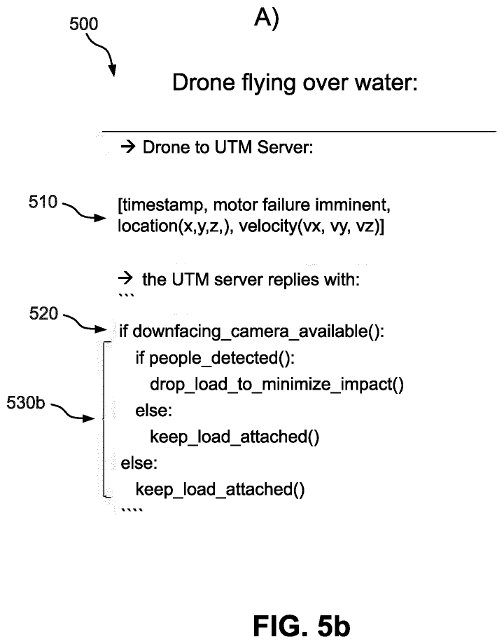

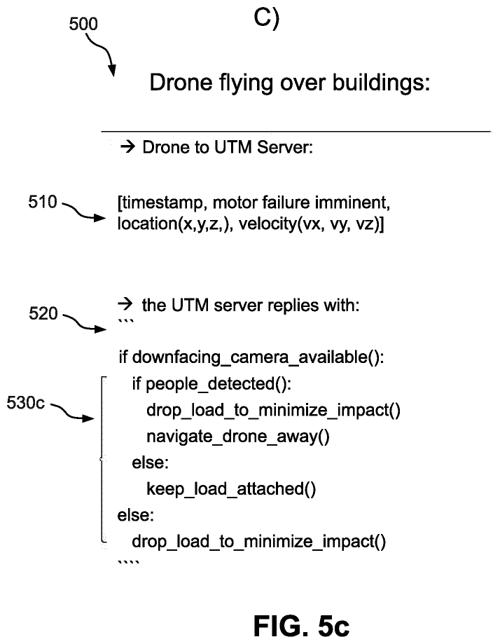

FIGS. 5a, 5b and 5c illustrate “pseudo-codes” which reflect examples of a computer program 500 for risk mitigation.

FIG. 5a schematically illustrates a first example of the computer program 500 for risk mitigation in the scenario of FIG. 2a.

Through a first instruction 510, the computer program 500 queries if a motor failure/technical problem is imminent and retrieves an input including a time-stamp, a location, a velocity of the aerial vehicle/UAV and for predicting the crash and the crash site.

The input, for example, can be generated by the aforementioned pre-crash warning system and the localization system.

Subsequently, a second instruction 520 queries if a (down-facing) camera (of the environmental monitoring system) is available for monitoring the environment.

A third instruction 530a may determine whether the aerial vehicle/UAV performs a ballistic load drop or self-destruction depending on whether the camera is available and depending on whether people/humans are within the monitored environment or not.

The third instruction 530a causes self-destruction if the camera is not available or if people are detected, and a ballistic load drop if not.

A second example of the computer program 500, illustrated in FIG. 5b, relates to risk mitigation in the scenario of FIG. 2b.

In contrast to the first example of the computer program, a third instruction 530b of the second example causes a load drop (e.g. ballistic load drop, active load ejection or tethered load drop) if a boat has been detected using the camera.

Otherwise, the third instruction 530b causes the UAV to keep the load attached.

A third example of the computer program 500, illustrated in FIG. 5c, relates to risk mitigation in cases in which any property (e.g. cars or buildings) are within the environment.

Here, a third instruction 530c causes the UAV to drop the load and to fly away if any property has been detected to mitigate an impact of the UAV and to prevent the UAV from a collision with the property.

Otherwise, according to the third instruction 530c , the UAV may keep the load attached if no property has been detected and to drop the load 130 if no camera is available.

The following examples pertain to further embodiments:
(1) An aerial vehicle for carrying a load, the aerial vehicle comprising:
   an environmental monitoring system configured to monitor the environment of the aerial vehicle; and
   a data processing circuitry configured to
      determine, based on the monitored environment, a risk to the environment posed by at least one of the aerial vehicle and the load of the aerial vehicle in case of a crash of the aerial vehicle; and
      cause, based on the determined risk, the aerial vehicle to carry out an action in order to reduce a damage to the environment in case of the crash.
(2) Aerial vehicle of (1), wherein the environmental monitoring system comprises a lidar sensor.
(3) Aerial vehicle of (1) or (2), wherein the environmental monitoring system comprises a radar sensor.
(4) Aerial vehicle of any one of (1) to (3), wherein the environmental monitoring system comprises a thermal imager.
(5) Aerial vehicle of any one of (1) to (4), further comprising
   a localization system configured to:
      determine spatial coordinates and a velocity of the aerial vehicle; and
      calculate a crash site of the crash within the environment from the spatial coordinates and the velocity of the aerial vehicle,
   wherein the data processing circuitry is further configured to:
      receive the crash site from the localization system; and
      determine, based on the received crash site, a risk to the crash site posed by at least one of the aerial vehicle and the load in case of the crash of the aerial vehicle.
(6) Aerial vehicle of any one of (1) to (5),
   further comprising a load release system configured to release the load from the aerial vehicle,
   wherein the data processing circuitry is configured to cause the aerial vehicle, based on the risk to the environment, to carry out an action which comprises releasing the load from the aerial vehicle using the load release system.
(7) Aerial vehicle of (6),
   wherein the load release system is further configured to eject the load; and
   wherein the data processing circuitry is configured to cause the aerial vehicle, based on the risk to the environment, to carry out an action which comprises ejecting the load from the aerial vehicle using the load release system.
(8) Aerial vehicle of (6) or (7),
   wherein the load release system is configured to lower the load down on a rope; and
   wherein the data processing circuitry is configured to cause the aerial vehicle, based on the risk to the environment, to carry out an action which comprises lowering the load down on the rope using the load release system.
(9) Aerial vehicle of any one of (1) to (8), further comprising an energy monitoring system configured to
   determine an actuation capability of the aerial vehicle; and
   provide the actuation capability to the data processing circuitry,
wherein the data processing circuitry is configured to cause the aerial vehicle, based on the actuation capability, to carry out an action which comprises an emergency landing.
(10) Aerial vehicle of any one of (1) to (9), further comprising an explosive device,
   wherein the data processing circuitry is configured to cause the aerial vehicle, based on the risk to the environment, to carry out an action which comprises decomposing the load and/or the aerial vehicle using the explosive device to reduce the damage caused by an impact of the load and/or the aerial vehicle in case of the crash.
(11) Aerial vehicle of any one of (1) to (10),
   further comprising a fuel tank configured to release fuel under control of the data processing circuitry;
   wherein the data processing circuitry is configured to cause the aerial vehicle, based on the risk to the environment, to carry out an action which comprises releasing fuel from the fuel tank to reduce the damage emanating from the fuel in case of the crash.
(12) Aerial vehicle of any one of (1) to (11), wherein the aerial vehicle is an unmanned aerial vehicle, UAV.
(13) A method for reducing a damage to an environment as consequence of a crash of an aerial vehicle, comprising:
   monitoring the environment of the aerial vehicle;
   determining, based on the monitored environment, a risk to the environment posed by at least one of the aerial vehicle and a load of the aerial vehicle in case of a crash of the aerial vehicle; and
   causing, based on the determined risk, the aerial vehicle to carry out an action in order to reduce the damage to the environment in case of the crash.
(14) A computer program comprising instructions, which, when the computer program is executed by a processor cause the processor to carry out the method of (13).

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for illustrative purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a signal”, “means for generating a signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software, but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. An aerial vehicle for carrying a load, the aerial vehicle comprising:
an environmental monitoring system configured to monitor the environment of the aerial vehicle; and
a data processing circuitry configured to
determine, based on the monitored environment, a risk to the environment posed by at least one of the aerial vehicle and the load of the aerial vehicle in case of a crash of the aerial vehicle; and
cause, based on the determined risk, the aerial vehicle to carry out an action in order to reduce a damage to the environment in case of the crash.

2. Aerial vehicle of claim 1, wherein the environmental monitoring system comprises a lidar sensor.

3. Aerial vehicle of claim 1, wherein the environmental monitoring system comprises a radar sensor.

4. Aerial vehicle of claim 1, wherein the environmental monitoring system comprises a thermal imager.

5. Aerial vehicle of claim 1, further comprising
a localization system configured to:
determine spatial coordinates and a velocity of the aerial vehicle; and
calculate a crash site of the crash within the environment from the spatial co-ordinates and the velocity of the aerial vehicle,
wherein the data processing circuitry is further configured to:
receive the crash site from the localization system; and
determine, based on the received crash site, a risk to the crash site posed by at least one of the aerial vehicle and the load in case of the crash of the aerial vehicle.

6. Aerial vehicle of claim 1,
further comprising a load release system configured to release the load from the aerial vehicle,
wherein the data processing circuitry is configured to cause the aerial vehicle, based on the risk to the environment, to carry out an action which comprises releasing the load from the aerial vehicle using the load release system.

7. Aerial vehicle of claim 6,
wherein the load release system is further configured to eject the load; and
wherein the data processing circuitry is configured to cause the aerial vehicle, based on the risk to the environment, to carry out an action which comprises ejecting the load from the aerial vehicle using the load release system.

8. Aerial vehicle of claim 6,
wherein the load release system is configured to lower the load down on a rope; and
wherein the data processing circuitry is configured to cause the aerial vehicle, based on the risk to the environment, to carry out an action which comprises lowering the load down on the rope using the load release system.

9. Aerial vehicle of claim 1, further comprising an energy monitoring system configured to
determine an actuation capability of the aerial vehicle; and
provide the actuation capability to the data processing circuitry,
wherein the data processing circuitry is configured to cause the aerial vehicle, based on the actuation capability, to carry out an action which comprises an emergency landing.

10. Aerial vehicle of claim 1, further comprising an explosive device,
wherein the data processing circuitry is configured to cause the aerial vehicle, based on the risk to the environment, to carry out an action which comprises decomposing the load and/or the aerial vehicle using the explosive device to reduce the damage caused by an impact of the load and/or the aerial vehicle in case of the crash.

11. Aerial vehicle of claim 1, further comprising a fuel tank configured to release fuel under control of the data processing circuitry;
wherein the data processing circuitry is configured to cause the aerial vehicle, based on the risk to the environment, to carry out an action which comprises releasing fuel from the fuel tank to reduce the damage emanating from the fuel in case of the crash.

12. Aerial vehicle of claim 1, wherein the aerial vehicle is an unmanned aerial vehicle, UAV.

13. A method for reducing a damage to an environment as consequence of a crash of an aerial vehicle, comprising:
monitoring the environment of the aerial vehicle;
determining, based on the monitored environment, a risk to the environment posed by at least one of the aerial vehicle and a load of the aerial vehicle in case of a crash of the aerial vehicle; and
causing, based on the determined risk, the aerial vehicle to carry out an action in order to reduce the damage to the environment in case of the crash.

14. A computer program comprising instructions, which, when the computer program is executed by a processor cause the processor to carry out the method of claim 13.
